(19) United States
(12) Patent Application Publication
(10) Pub. No.: US 2007/0068529 A1
(43) Pub. Date: Mar. 29, 2007

(54) Respirator that uses a polymeric nose clip

(76) Inventors: Suresh Kalatoor, Cottage Grove, MN (US); Myles L. Brostrom, West LakelandTownship, MN (US); Thomas J. Xue, St. Paul, MN (US)

Correspondence Address: 3M INNOVATIVE PROPERTIES COMPANY, PO BOX 33427, ST. PAUL, MN, 55133-3427, US

(21) Appl. No.: 11/236,283

(22) Filed: Sep. 27, 2005

(51) Int. Cl. A62B 23/02

(52) U.S. Cl. 128/206.19

(57) ABSTRACT

A respirator 10 that has a mask body 14 and a malleable nose clip 12. The mask body 14 is adapted to fit at least over the nose and mouth of a person to define an interior gas space that is separate from the exterior gas space. The mask body 14 has the nose clip 12 secured to it and can include at least one layer of filter media 20. The malleable nose clip 12 comprises a semi-crystalline polymeric material that has an integrated diffraction intensity ratio of at least about 2.0. The nose clip 12 can be deformed into a desired configuration that enables the mask body 14 to maintain a snug fit over a person's nose when the respirator is worn for extended time periods. Because the nose clip 12 does not need to contain metal, the whole respirator 10 can be easily processed as waste in an incinerator when its service has ended.

The present invention pertains to a respiratory mask that has a nose clip that comprises a thermoplastic semi-crystalline polymeric material that has an integrated diffraction intensity ratio of at least about 2.0. The inventive nose clip is manually pliable while also exhibiting good shape retention.

### BACKGROUND

Respirators (sometimes referred to as “filtering face masks” or “filtering face pieces”) are generally worn over the breathing passages of a person for two common purposes: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

To meet these purposes, the respirator must be able to maintain a snug fit to the wearer's face. Known respirators can, for the most part, match the contour of a person's face over the cheeks and chin. In the nose region, however, there is a radical change in contour, which makes a snug fit difficult to achieve. The failure to obtain a snug fit can be problematic in that air can enter or exit the respirator interior without passing through the filter media. When this happens, contaminants may enter the wearer's breathing track, and other persons or things may become exposed to contaminants exhaled by the wearer. In addition, a wearer's eyeglasses can fog when the exhalate escapes from the respirator interior over the nose region. Fogged eyewear, of course, makes visibility more troublesome to the wearer and creates unsafe conditions for the user and others.

Nose clips are commonly used on respirators to achieve a snug fit over the wearer's nose. Conventional nose clips are in the form of malleable, linear, strips of aluminum—see, for example, U.S. Pat. Nos. 5,307,796, 4,600,002, and 3,603,315 and U.K. Patent Application GB 2,103,491 A. A more recent product has uses an “M” shaped band of aluminum to improve fit over the wearer's nose—see U.S. Pat. Nos. 5,558,089 and Des. 412,573 to Castiglione. The “M” shaped nose clip is available on 3M 8211™, 8511™, 8271™, 8516™, 8576™, and 8577™ particulate respirators.

Although metal nose clips are able to provide a snug fit over the wearer's nose, they can pose drawbacks from disposal and environmental safety standpoints. Unlike plastic components, metal nose clips cannot be easily burned in an incinerator. Additionally, there is a potential risk that the nose clip could come loose from the mask body and be deposited in the surrounding environment. In some industries, there is a need to minimize opportunities for metal to become accidentally deposited in a manufacturing operation. Food processors, for example, have expressed a desire for workers to wear respirators that have no metal parts (such as nose clips or staples) to prevent those parts from getting into foodstuffs. Although plastic nose clips have been used on respiratory masks, these known nose clips have not achieved widespread acceptance because they do not exhibit particularly good shape retention characteristics after being conformed to their desired shape.

### SUMMARY OF THE INVENTION

The present invention provides a respirator that comprises a mask body and a nose clip. The nose clip is secured to the mask body and comprises a malleable thermoplastic semi-crystalline polymeric material that has an integrated diffraction intensity ratio of at least about 2.0.

As indicated above, known respirators have predominantly used metal nose clips to achieve a snug fit over a person's nose. Although attempts have been made to replace the metal device with a plastic nose clip, the success has been limited because the plastic that has been used, albeit malleable, has had a tendency to exhibit memory, which precludes the clip from retaining its adapted shape. The inventive nose clip represents an advance in the respirator art in that it provides a plastic nose clip that demonstrates good malleability and good shape retention characteristics. To achieve both of these performance characteristics, the nose clip includes a thermoplastic semi-crystalline polymeric material that has an integrated diffraction intensity ratio of at least about 2.0. Known respirator nose clips have not used such plastic materials.

The inventive polymeric nose clip can maintain a snug fit over the wearer's nose without substantially restricting flow through the nasal passages of the wearer and without causing uncomfortable pressure points. The inventive nose clip helps prevent inhaled and exhaled air from passing from the respirator interior to the exterior or vice versa without passing through the filter media. Because the inventive nose clip does not need to contain metal to achieve its purpose, its use is less hazardous in food processing and surgical procedures. The respirator also can be easily incinerated when the mask has met the end of its service life. The inventive nose clip thus is beneficial in that it can provide shape retention characteristics similar to a metal nose clip but without the need for—and drawbacks of—using metal.

These and other features and advantages of the invention are more fully shown and described in the drawings and detailed description of this invention, where like reference numerals are used to represent similar parts. The drawings and description are for illustration purposes only, however, and should not be read in a manner that would unduly limit the scope of this invention.

### GLOSSARY

The terms set forth below will have the meanings as defined:

“aerosol” means a gas that contains suspended particles in solid and/or liquid form;

“aspect ratio” means the ratio of the length of an object to its effective hydraulic diameter; for a circular rod of length (L) and diameter (D), the aspect ratio is L:D (see Example section for calculation of effective hydraulic diameter);

“clean air” means a volume of atmospheric ambient air that has been filtered to remove contaminants;

“comprises (or comprising)” means its definition as is standard in patent terminology, being an open-ended term that is generally synonymous with “includes”, “having”, or “containing”. Although “comprises”, “includes”, “having”, and “containing” are commonly-used, open-ended terms, this invention also may be described using narrower terms such as “consists essentially of”, which is semi open-ended term in that it excludes only those things or elements that would have a deleterious effect on the performance of the nose clip in serving its intended function;

“contaminants” means particles (including dusts, mists, and fumes) and/or other substances that generally may not be considered to be particles (e.g., organic vapors, et cetera) but which may be suspended in air, including air in an exhale flow stream;

“crosswise dimension” is the dimension that extends across a wearer's nose when the respirator is worn; it is synonymous with the “length” dimension of the nose clip.

“crystallinity index” means the fractional crystallinity determined according to the Crystallinity Index Method described below;

“exhalation valve” means a valve that has been designed for use on a respirator to open unidirectionally in response to pressure or force from exhaled air;

“exhaled air” is air that is exhaled by a respirator wearer;

“exterior gas space” means the ambient atmospheric gas space into which exhaled gas enters after passing through and beyond the mask body and/or exhalation valve;

“filter media” means an air-permeable structure that is capable of removing contaminants from air that passes through it;

“harness” means a structure or combination of parts that assists in supporting the mask body on a wearer's face;

“integrated diffraction intensity ratio” means a unitless parameter determined according to the X-ray Diffraction Pole Figure Analysis described below;

“interior gas space” means the space between a mask body and a person's face;

“lengthwise dimension” means the direction of the length (long axis) of the nose clip (which extends across the bridge of the wearer's nose when the mask is worn);

“malleable” means deformable in response to mere finger pressure;

“mask body” means an air-permeable structure that can fit at least over the nose and mouth of a person and that helps define an interior gas space separated from an exterior gas space;

“memory” means that the deformed part has a tendency to return to its preexisting shape after deforming forces have ceased;

“midsection” is the central part of the nose clip that extends over the bridge or top of a wearer's nose;

“nose clip” means a mechanical device (other than a nose foam), which device is adapted for use on a filtering face mask to improve the seal at least around a wearer's nose;

“nose foam” means a compressible porous material that is adapted for placement on the interior of a mask body to improve the fit and/or comfort over the nose;

“particles” means any liquid and/or solid substances that is capable of being suspended in air, for example, dusts, mists, fumes, pathogens, bacteria, viruses, mucous, saliva, blood, etc.;

“pole figure” is a two-dimensional representation of a three-dimensional intensity distribution produced by a given diffraction plane;

“polymer” means a material that contains repeating chemical units, regularly or irregularly arranged;

“polymeric and plastic” means that the material mainly includes one or more polymers and may contain other ingredients as well;

“porous structure” means a mixture of a volume of solid material and a volume of voids, which mixture defines a three-dimensional system of interstitial, tortuous channels through which a gas can pass;

“portion” means part of a larger thing;

“shape-retainable” means that the shape is substantially retained after any deforming forces have ceased;

“semi-crystalline” means having crystalline domains;

“snug fit” or “fit snugly” means that an essentially air-tight (or substantially leak-free) fit is provided (between the mask body and the wearer's face);

“strand or stranded” means a filament that has an aspect ratio of at least about 10;

“thermoplastic” means a polymer that may be softened by heat and hardened by cooling in a reversible physical process; and

“transverse dimension” means the dimension that extends at a right angle to the lengthwise dimension (and along the length of the wearer's nose when worn).

### BRIEF DESCRIPTION OF THE DRAWINGS

FIG. 1 is a front view of a respiratory mask 10 in accordance with a present invention, showing the nose clip 12 in its commercially available, or non-deformed condition.

FIG. 2 is front view of a respiratory mask 10 in accordance with the present invention, showing the nose clip 12 in a deformed condition.

FIG. 3 is a sectional view of respiratory mask 10 taken along lines 3-3 of FIG. 1.

FIG. 4 is a sectional view of a respiratory mask 10′, illustrating a second embodiment of a nose clip 12′.

FIG. 5 is a sectional view of a respiratory mask 10″, illustrating a third embodiment of a nose clip 12″.

FIG. 6 is an image of a “pole figure”, and an accompanying plot of normalized intensity derived from the pole figure, for the material used in the nose clip of Example 1 and Example 2. The pole figure and normalized intensity represent crystalline orientation in the lengthwise-dimension of the sample.

FIG. 7 is an image of a “pole figure”, and accompanying plot of normalized intensity derived from the pole figure, for the material used in the nose clip of Example 1 and Example 2. The pole figure and normalized intensity represent crystalline orientation in the transverse-dimension of the sample.

FIG. 8 is an image of a “pole figure”, and accompanying plot of normalized intensity derived from the pole figure, for the material used in the nose clip of Comparative Example 1. The pole figure and normalized intensity represent crystalline orientation in the lengthwise-dimension of the sample.

FIG. 9 is an image of a “pole figure”, and accompanying plot of normalized intensity derived from the pole figure, for the material used in the nose clip of Comparative Example 1. The pole figure and normalized intensity represent crystalline orientation in the transverse-dimension of the sample.

FIG. 10 is an image of a “pole figure”, and accompanying plot of normalized intensity derived from the pole figure, for the material used in the nose clip of Comparative Example 2. The pole figure and normalized intensity represent crystalline orientation in the lengthwise-dimension of the sample.

FIG. 11 is an image of a “pole figure”, and accompanying plot of normalized intensity derived from the pole figure, for the material used in the nose clip of Comparative Example 2. The pole figure and normalized intensity represent crystalline orientation in the transverse-dimension of the sample.

### DETAILED DESCRIPTION OF THE PREFERRED EMBODIMENTS

In describing preferred embodiments of the invention, specific terminology is used for the sake of clarity. The invention, however, is not intended to be limited to the specific terms so selected; each term so selected includes all technical equivalents that operate similarly.

In the practice of the present invention, a new nose clip is provided for use on a respiratory mask. The new nose clip includes a malleable, thermoplastic, semi-crystalline polymeric material that has an integrated diffraction intensity ratio of at least about 2.0. In order to provide the necessary combination of ease of deformation (to achieve fit) and resistance to relaxation (to maintain fit), the inventors have found that the nose clip should carry both desired intrinsic deformation and recovery strain. The inventors discovered that the deformation properties of the nose clip may be achieved through use of semi-crystalline, malleable, thermoplastic polymeric material that preferably has controlled crystallite orientation within the crystalline domains such that the molecular chain is aligned in the lengthwise-dimension of the article. The crystallite orientation is defined in accordance with the present invention using the parameter “integrated diffraction intensity ratio”.

Both crystallinity and crystallite orientation have a bearing on the deformation and recovery properties. Crystallinity tends to affect stiffniess and/or bending strain characteristics of crystalline polymers. In crystalline thermoplastic resins, there exist crystalline regions where polymer molecules pack regularly and compactly, and non-crystalline regions where molecular packing is somewhat irregular and less compact. The crystalline regions are believed to contribute to the flexural rigidity of the material, owing to less free volume and more restricted polymer chain motion. Consequently, increasing a proportion of crystalline regions, or overall crystallinity, generally increases material stiffness. Crystallite orientation has not been generally recognized by persons skilled in this art as a property that influences the ease of deformation and subsequent resistance to recovery after bending of a crystalline polymer element. In particular, the crystallite orientation has not been recognized for providing beneficial affects to the performance of a nose clip on a respirator. This benefit in ease of deformation and subsequent resistance to recovery of structural crystalline polymers elements has been discovered to arise from the alignment of the crystalline regions, in the direction along which deformation will occur.

The inventors found that nose clips that have certain degree of crystallinity and particular crystallite orientation of the polymeric material exhibit good malleability and shape-retention properties. The benefits of the invention are particularly derived when the crystallite orientation is along the plane of deformation or bending of the nose clip element. The present invention provides a nose clip for use with a respiratory facemask where crystalline thermoplastic resin is extruded in the form of films, sheets, rods, strands, and variations thereof to provide a nose clip that exhibits high resistance to recovery after deformation. The polymeric material may be provided with crystalline and non-crystalline regions, wherein the crystal molecular chain axis direction of the crystalline regions orients uniaxially and uniplanarly. The thermoplastic polymeric material is “semi-crystalline” in that it contains crystalline and non-crystalline domains. The crystallite orientation may be optimized by the following: (a) the crystallinity index is at least about 0.5, preferably at least about 0.6, more preferably at least about 0.7, and (b) the degree of the orientation of the crystalline domain is predominately along the lengthwise-dimension with an integrated diffraction intensity ratio of at least about 2.0, preferably at least about 2.5, more preferably at least about 3.0. The integrated diffraction intensity for the lengthwise dimension may be at least about 40, 50, or 60 intensity-degree.

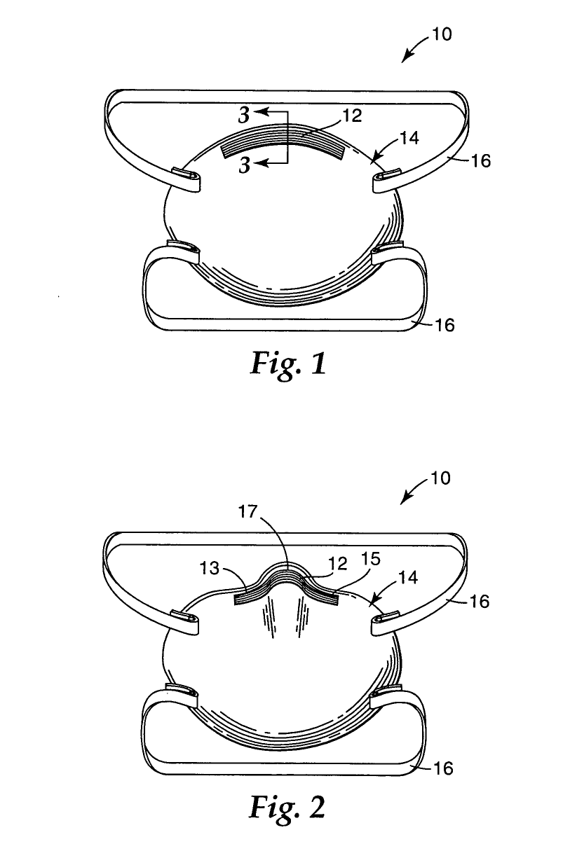

FIG. 1 illustrates a respiratory mask 10 that has a nose clip 12 disposed on a mask body 14. The nose clip 12 comprises a polymeric material that preferably has a crystallinity index of at least about 0.5 and has an integrated diffraction intensity ratio of at least about 2.0. The nose clip extends over the bridge of a wearer's nose when the mask is being worn. The nose clip 12 is constructed so that it can be conformed by mere finger pressure. The polymeric material furnishes the nose clip with malleable characteristics and its “shape retainable” ability so that when conformed to the wearer's face, it can retain much of its conformed position until it is readjusted or altered by the wearer.

Mask body 14 is adapted to fit over the nose and mouth of a person in spaced relation to the wearer's face to create an interior gas space or void between the wearer's face and the interior surface of the mask body. The mask body 14 may be of a curved, hemispherical, cup-shape such as shown in FIG. 1—see also U.S. Pat. No. 4,536,440 to Berg, U.S. Pat. No. 4,807,619 to Dyrud et al., and U.S. Pat. No. 5,307,796 to Kronzer et al. The respirator body also may take on other shapes as so desired. For example, the mask body can be a cup-shaped mask having a construction as shown in U.S. Pat No. 4,827,924 to Japuntich. The mask body also may be a flat-folded product like the bi-fold and tri-fold mask products disclosed in U.S. Pat. Nos. 6,722,366 and 6,715,489 to Bostock, D459,471 and D458,364 to Curran et al., and D448,472 and D443,927 to Chen. See also U.S. Pat. Nos. 4,419,993, 4,419,994, 4,300,549, 4,802,473, and Re. 28,102. The mask body may include one or more layers of filter media. Commonly, a nonwoven web of electrically-charged microfibers—i.e., fibers having an effective diameter of about 25 micrometers (μm) or less (typically about 1 to 15 μm)—is used as a layer of filter media. Filter media can be charged according to U.S. Pat. No. 6,119,691 to Angadjivand et al. Essentially any presently known (or later developed) mask body that is air permeable and that includes a layer of filter media could be used in connection with this invention.

As shown in FIG. 1, the respirator 10 also includes a harness such as straps 16 that are sized to pass behind the wearer's head to assist in providing a snug fit to the wearer's face. The straps 16 preferably are made of an elastic material that causes the mask body 14 to exert a slight pressure on the face of the wearer. A number of different materials may be suitable for use as straps 16, for example, the straps may be formed from a thermoplastic elastomer that is ultrasonically welded to the respirator body. Ultrasonic welding may be beneficial over the use of staples to fasten the harness to the mask body since metal is not used. The 3M 8210™ particulate respirator is an example of a filtering face mask that employs ultrasonically welded straps. Woven cotton elastic bands, rubber cords (e.g. polyisoprene rubber) and/or strands also may be used, as well as non-elastic adjustable straps—see U.S. Pat. No. 6,705,317 to Castiglione and U.S. Pat No. 6,332,465 to Xue et al. Other examples of mask harnesses that may be used in connection with the present invention are shown in U.S. Pat. Nos. 6,457,473B1, 6,062,221, and 5,394,568, to Brostrom et al., U.S. Pat. Nos. 6,591,837, 6,119,692 and 5,464,010 to Byram, and U.S. Pat. Nos. 6,095,143 and 5,819,731 to Dyrud et al. Essentially any strap system (presently known or later-developed) that is fashioned for use in supporting a respiratory face piece on a wearer's head could be used as a harness in connection with the present invention. The harness also could include a head cradle in conjunction with one or more straps for supporting the mask. The respirator also can have an exhalation valve located thereon such as the unidirectional fluid valve disclosed in U.S. Pat. No. 6,854,463 to Japuntich et al. An exhalation valve allows exhaled air to escape from the interior gas space without having to pass through the filter media in the mask body 14. The exhalation valve can be secured to the mask body through use of an adhesive—see U.S. Pat. No. 6,125,849 to Williams et al.—or by mechanical clamping—see U.S. Pat. No. 6,604,524 to Curran et al. The illustrated mask body 14 is fluid permeable and may be provided with an opening (not shown) that is located where an exhalation valve would be attached to the mask body 14 so that exhaled air can rapidly exit the interior gas space through the exhalation valve 14. The preferred location of the opening on the mask body 14 is directly in front of where the wearer's mouth would be when the mask is being worn. The placement of the opening, and hence the exhalation valve, at this location allows the valve to open more easily in response to the force or momentum from the exhale flow stream. For a mask body 14 of the type shown in FIG. 1, essentially the entire exposed surface of mask body 14 is fluid permeable to inhaled air.

The mask body may be spaced from the wearer's face, or it may reside flush or in close proximity to it. In either instance, the mask body helps define an interior gas space into which exhaled air passes before leaving the mask interior through the exhalation valve. The mask body also could have a thermochromic fit-indicating seal at its periphery to allow the wearer to easily ascertain if a proper fit has been established—see U.S. Pat. No. 5,617,849 to Springett et al.

FIG. 2 shows the respiratory mask 10 of FIG. 1 with the nose clip 12 being deformed to fit snugly over a person's nose. When the nose clip 12 is so deformed, it generally has first and second wing portions 13 and 15 that are joined by a curved midsection 17. The wing portions 13 and 15 help prevent air from passing between the mask and the wearer's face in the region where the nose meets the cheek. The curved midsection 17 provides a snug fit over the bridge of the wearer's nose. As illustrated, the midsection 17 generally approximates a 180° turn over the bridge of the wearer's nose. In deformed condition, the nose clip has an increasing slope from the first wing 13 to the midsection 17 and has a decreasing variable slope from the midsection 17 to the second wing 15. In contrast, the masks that are furnished to the user (before nose clip deformation) generally exhibit a constant curve (see FIG. 1).

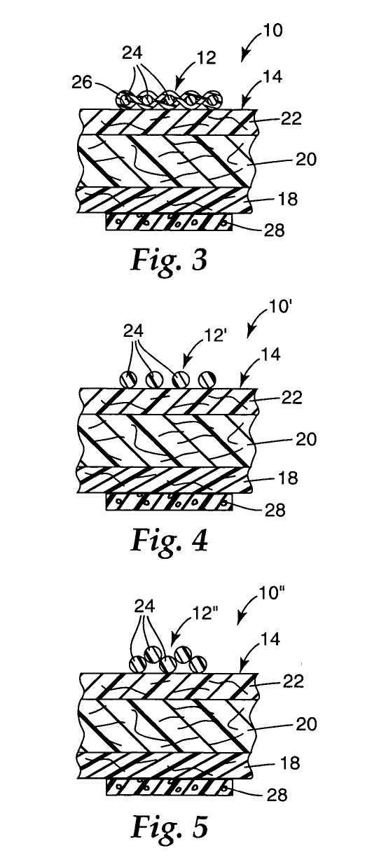

As shown in FIGS. 3-5, the mask body 14 may comprise multiple layers, including an inner stiffening or shaping layer 18, a filtration layer 20, and an outer cover web 22. The inner stiffening or shaping layer 18 provides structure to the respirator body 14 and support for the filtration layer 20. Layer 18 can be located on the inside and/or outside of the filtration layer and can be made, for example, from a non-woven web of thermally-bondable fibers that have been molded into, for example, a cup-shaped configuration by, for example, the method taught in U.S. Pat. No. 5,307,796 to Kronzer et al. A shaping layer also could be made from a molded plastic net—see U.S. Pat. No. 4,850,347 to Skov. Although layer 18 is designed with the primary purpose of providing structure to the mask and providing support for a filtration layer, the layer 18 also may act as a filter, typically for capturing larger particles suspended in the exterior gas space, if disposed outside of the filter layer. Together layers 18 and 20 may operate as an inhale filter element. When a wearer inhales, air is drawn through the mask body, and airborne particles become trapped in the interstices between the fibers, particularly the fibers in the filter layer 20. In the embodiment shown in FIGS. 3-5, the filter layer 20 is “integral” with the mask body 12—that is, it forms part of the mask body and is not an item that subsequently becomes attached to (or removed from) the mask body like a filter cartridge. The mask body also may have a layer of foam material 28 disposed on the inner side of the mask body in the nose region to assist in providing a comfortable snug fit.

Filtering materials that are commonplace on negative pressure half mask respirators—like the filtering face mask 10 shown in FIGS. 1 and 2—often contain an entangled web of electrically charged microfibers, particularly meltblown microfibers (BMF). Microfibers typically have an average effective fiber diameter of about 20 to 25 micrometers (μm) or less, but commonly are about 1 to about 15 μm, and still more commonly be about 3 to 10 μm in diameter. Effective fiber diameter may be calculated as described in Davies, C. N., The Separation of Airborne Dust and Particles, Institution of Mechanical Engineers, London, Proceedings 1B. 1952. BMF webs can be formed as described in Wente, Van A., Superfine Thermoplastic Fibers in Industrial Engineering Chemistry, vol. 48, pages 1342 et seq. (1956) or in Report No. 4364 of the Naval Research Laboratories, published May 25, 1954, entitled Manufacture of Superfine Organic Fibers by Wente, Van A., Boone, C. D., and Fluharty, E. L. Meltblown fibrous webs can be uniformly prepared and may contain multiple layers, like the webs described in U.S. Pat. Nos. 6,492,286B1 and 6,139,308 to Berrigan et al. When in the form of a randomly entangled web, BMF webs can have sufficient integrity to be handled as a mat. Electric charge can be imparted to fibrous webs using techniques described in, for example, U.S. Pat. Nos. 6,454,986B1 and 6,406,657B1 to Eitzman et al.; U.S. Pat. Nos. 6,375,886B1, 6,119,691 and 5,496,507 to Angadjivand et al., U.S. Pat. No. 4,215,682 to Kubik et al., and U.S. Pat. No. 4,592,815 to Nakao.

Examples of fibrous materials that may be used as filters in a mask body are disclosed in U.S. Pat. No. 5,706,804 to Baumann et al., U.S. Pat. No. 4,419,993 to Peterson, U.S. Reissue Pat. No. Re 28,102 to Mayhew, U.S. Pat. Nos. 5,472,481 and 5,411,576 to Jones et al., and U.S. Pat. No. 5,908,598 to Rousseau et al. The fibers may contain polymers such as polypropylene and/or poly-4-methyl-1-pentene (see U.S. Pat. No. 4,874,399 to Jones et al. and U.S. Pat. No. 6,057,256 to Dyrud et al.) and may also contain fluorine atoms and/or other additives to enhance filtration performance—see, U.S. Pat. Nos. 6,432,175B1, 6,409,806B1, 6,398,847B1, 6,397,458B1 to Jones et al. and U.S. Pat. Nos. 5,025,052 and 5,099,026 to Crater et al., and may also have low levels of extractable hydrocarbons to improve performance—see U.S. Pat. No. 6,213,122 to Rousseau et al. Fibrous webs also may be fabricated to have increased oily mist resistance as described in U.S. Pat. No. 4,874,399 to Reed et al., and in U.S. Pat. Nos. 6,238,466 and 6,068,799, both to Rousseau et al. The filtration layer optionally could be corrugated as described in U.S. Pat. Nos. 5,804,295 and 5,763,078 to Braun. The mask body also can include an outer cover web 22 to protect the filtration layer. The cover web may be made from nonwoven webs of BMF as well, or alternatively from webs of spunbond fibers. An inner cover web also could be used to provide the mask with a soft comfortable fit to the wearer's face—see U.S. Pat. No. 6,041,782 to Angadjivand et al. The cover webs also may have filtering abilities, although typically not nearly as good as the filtering layer 20.

Preferably, the nose clip comprises a polymeric material that is in the form of strands that generally have large aspect ratios. The aspect ratio may be at least 50, at least 100, and still at least 300. The aspect ratio also could be as high as about 450 to 500. The polymeric strand(s) can be, for instance, bundled together in various configurations or used individually. FIGS. 3-5 show how the nose clip 12 may have a plurality of polymeric strands 24. These strands 24 may be used together to form a malleable, shape-retaining, nose clip 12, 12′, or 12″. The strands may be joined together by encasing them in a polymeric material 26 as shown in FIG. 3, or they may be individually secured to the mask body 14 as shown in FIG. 4. The casing 26 shown in FIG. 3 may be a woven network of fiber strands that encapsulate the strands and holds them in a fixed side-by-side orientation, but also allows them to slide within the network along their length. The strands also can be interconnected by braiding them together through use of fine threads. The strands generally reside in the same plane when viewed in cross-section, but there may be multiple layers of strands as shown in FIG. 5. The strands have a generally circular cross-section that has a diameter of about 0.3 to 1.5 mm, more typically 0.8 to 1.2 mm. The strands typically run the whole length of the nose clip but could be shorter as well. If shorter than the whole nose clip length, the strands may be attached (for example, at their ends) to a substrate material or sheeting that can “push against” the mask body to hold it in position against the wearer's nose or cheek. The nose clip typically has a total length of about 5 to 13 centimeters (cm), more typically about 7 to 10 cm long. The length of the malleable polymeric material usually is about the same length, and typically not less than 75% of the total nose clip length. The polymeric strands generally extend over the whole nose clip length but may be shorter if, for example, the substrate is disposed beneath the polymeric strands. The length of the nose clip is the measurement in the direction that extends across (or traverses) the bridge of a wearer's nose when the mask is worn. The length of the nose clip would be determined as the product is commercially available, that is, before being deformed by user. The nose clip width (that is, the dimension that is substantially in the same direction as the length of a wearer's nose) is about 0.7 to 1.2 cm wide, preferably about 0.8 to 1.0 cm wide. In addition to, or in lieu of, being circular in cross-section, the strands also could take on other configurations such as being square, rectangular, elliptical, etc. The nose clip typically has 2 to 10 strands, more typically 3 to 7 strands, and still more typically 4 to 6 strands per clip. The strands may be secured directly to the mask body 14, or they may be secured to a deformable plastic film or sheet, which film or sheet, in turn, may be secured to the mask body 14. The nose clip may be attached to the mask body through use of a variety of techniques, including ultrasonic welding and adhesive bonding.

The semi-crystalline thermoplastic polymeric material may include thermoplastic polymer(s) such as polyethylene, polypropylene, polyolefins, and combinations thereof. The polymeric material preferably has a recovery efficiency of at least 40%, preferably 50%, and more preferably 60%. The polymeric material also may have an elastic modulus of 10,000 to 20,000 Mega Pascals (MPa), and preferably 14,000 to 16,000 MPa. The inventive nose clip also preferably has a peak stress of not greater than 600 MPa, more preferably not greater than 400 MPa and has a return (recovery) stress of at least 50 MPa, more preferably at least 100 MPa. In addition to polymers, the thermoplastic polymeric material (and other parts of the nose clip, e.g., supporting substrate) may also include other ingredients such as dyes, filters, pigments, stabilizers, antimicrobial agents, and combinations thereof. The additional ingredients may be used in various amounts as long as they do not substantially adversely impact the malleable, shape-retaining characteristics of the nose clip. The thermoplastic polymer(s) that comprise the nose clip, preferably have a glass transition temperature T_{g} of at least 35° C., and preferably at least 50° C. The glass transition temperature preferably exceeds the highest anticipated temperature under which the respiratory mask may be used.

### Test Methods

X-Ray Diffraction Pole Figure Analysis

Through the use of wide-angle x-ray diffraction methods, orientations of crystallographic axis of polymeric materials can be determined stereoscopically and quantitatively. Pole figure analysis is a technique that is used with x-ray diffraction to quantitatively measure the degree of the uniaxial-uniplanar orientation, otherwise known as texture, of crystallites. The applications of pole figure analysis to polymeric materials are well recognized in the technical literature, see L. E. Alexander, X-ray Diffraction Methods in Polymer Science, WILEY-INTERSCIENCE (1969).

Reflection geometry data were collected in the form of survey scans and pole figures through use of a Huber 424-511.1 four circle diffractometer using a CuK_{α}radiation source, scintillation detector registry of the scattered radiation. Samples were positioned so as to place the lengthwise-dimension (LD) in the vertical plane and corresponded to a tilt angle setting of 0 degrees X and a rotation Φ angle setting of 0 degrees. The diffractometer used a pinhole collimation with a 700-micrometer (μm) aperture, fixed exit slits, and nickel filters. X-ray generator settings of 40 kilovolts (kV) and 30 milliamps (mA) were employed. Pole figure data were collected at tilt angles X of 0 to 75 degrees and rotation angles Φ from −180 to +180 degrees, each using a 5-degree step size. The intensity for the (2 0 0) maximum was sufficient that corrections for background and amorphous scattering were not required. For polymers of lower crystallinity (Index <0.6) and when significant background scattering is present, appropriate corrections to the intensity data should be made.

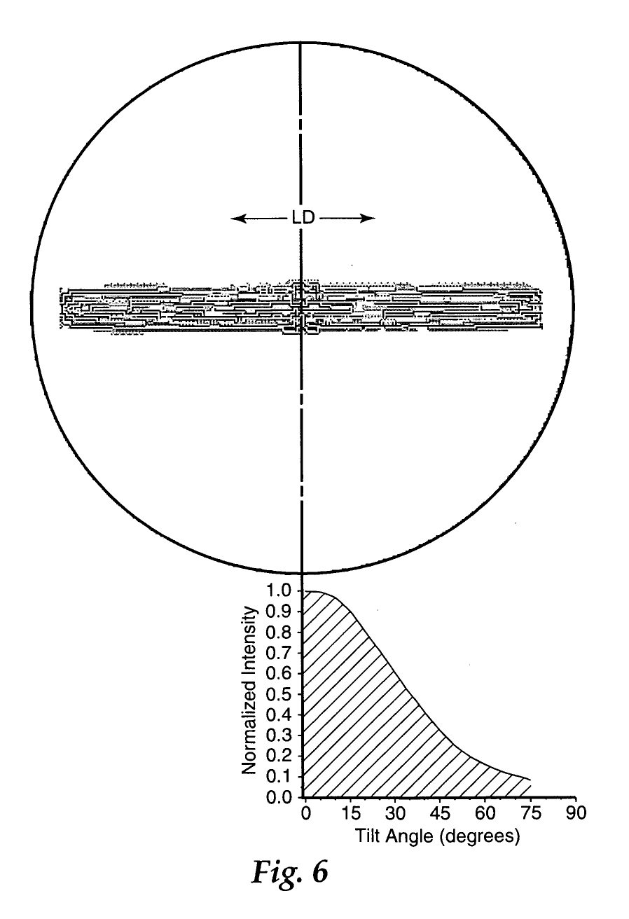

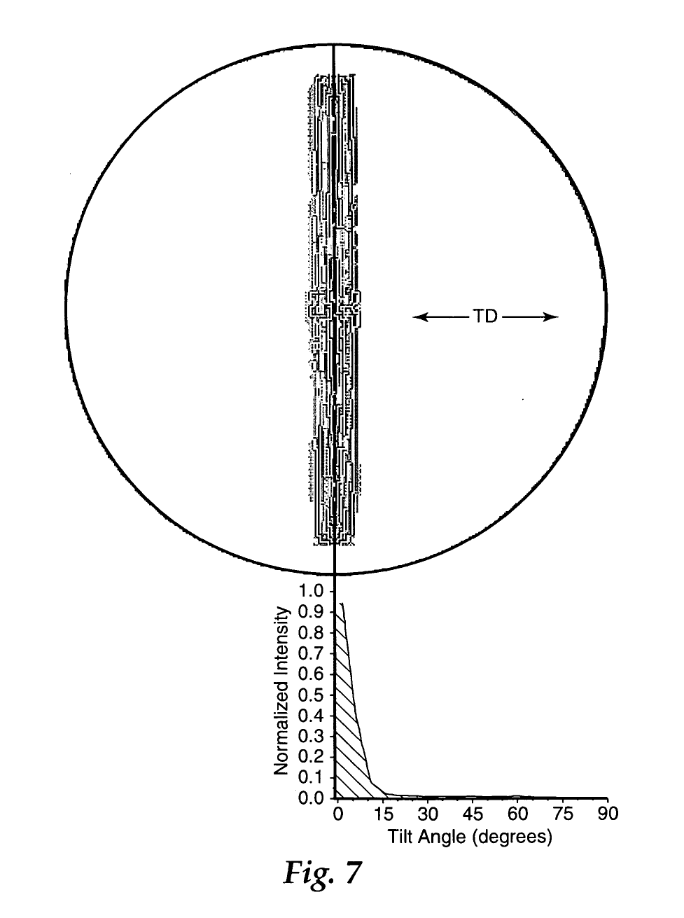

Crystal planes that are coaxial, or alternatively, normal to the polymer molecular chain axes are preferred for this characterization. The pole figures were two-dimensional representations of the three-dimensional intensity distribution produced by a given diffraction plane. The data were collected with reference to the sample geometry at selected values of azimuthal rotation and sample plane tilt. The data were plotted in the form of a stereographic projection, the resulting pole figure representing the sample tilt as a distance (radius) from the center of the figure. Azimuthal rotation was depicted as a rotation about the pole figure normal—see, for example, FIG. 6. A crystal plane that possesses no preferred orientation (random) produces a constant intensity over the pole figure, which indicates that the Bragg condition is met by a large range of sample tilt and azimuth rotation values. A crystal plane that demonstrates perfect alignment of the plane (akin to a single crystal) parallel to the sample plane would produce a single large intensity at the center of the figure since only a very narrow set of sample tilts and azimuth rotation will satisfy the Bragg condition for that set of planes. Deviations from these extremes distribute the intensity within the pole figure and correspond to more complex modes of orientation texture. At high levels of crystalline plane alignment, the crystallography of the examined structure becomes a dominant feature in determining where intensity is observed in the pole figure. The reason for this is that the crystal planes are physically related by an angular relationship because of the crystallography of the structure. Uniaxial (cylindrical) symmetry reveals itself as a band of intensity across the pole figure, along the principal direction of alignment. For the samples examined, crystallite alignment along the lengthwise-dimension (LD) of the sample was of primary interest.

When characterizing the molecular chain alignment of polyethylene, the pole figure of interest measures the intensity distribution for the orthorhombic (2 0 0) reflection. The pole figure of interest, when characterizing the molecular chain alignment of materials of the invention, was the (2 0 0) reflection. The (2 0 0) reflection plane runs parallel to the molecular chain axis. Since the (2 0 0) plane is parallel to the polymer chain axis, it can be used to measure the crystallite alignment level.

Intensity distributions for (2 0 0) pole figures were evaluated by taking intensity traces along the lengthwise and transverse dimensions of a nose clip specimen. Data evaluation was carried out by plotting the reflected intensity, normalized to the intensity measured at 0 degrees tilt, against tilt angle. The resulting normalized intensity trace was fitted by use of the program ORIGIN (Origin Lab Co., Northhampton, Mass.) to a Gaussian distribution. The ratio of cumulative reflected intensities (integrated area under the intensity plot, noted by cross-hatching in FIGS. 6-11), evaluated for the transverse and lengthwise-dimensions of a nose clip specimen, provided a measure of uniaxial molecular chain alignment. Chain alignment in the lengthwise-dimension of a nose clip specimen relates to alignment relative to the crosswise dimension of the nose clip as it is fitted on a facemask. Generally, the greater the LD/TD ratio of the integrated intensities, the greater the uniaxial alignment of the molecular chains in the crosswise dimension of the nose clip as it is placed on the facemask.

Crystallinity Index Method

For the crystallinity evaluation, data are collected in a 2D or “two-dimensional” mode to allow capture of the orientation effects by the detection system similar to using a photographic film but in a digital format. These 2D data are then reduced to one-dimensional data by radially averaging to remove the effects of orientation. Reducing to one-dimensional data set allows calculation of crystallinity index values from a data set that is not biased by the preferred orientation present in the sample.

Crystallinity index was determined using transmission geometry data collected in the form of survey scans through use of a Bruker GADDS Microdiffractometer (available from Bruker AXS Inc of Madison, Wis.), CuK_{α}radiation source, and HiStar 2D position sensitive detector registry of the scattered radiation. Samples were positioned so as to place the lengthwise dimension in the vertical plane of the diffractometer. The diffractometer was fitted with pinhole collimation that used a 300 micron aperture and graphite incident beam monochromator. The detector was centered at 0 degrees (2θ), and no sample tilt was employed. Data were accumulated for 15 minutes at a sample to detector distance of 6 cm. X-ray generator settings of 50 kV and 100 mA were employed; values of crystallinity were reported as an index of the percent crystallinity. Two-dimensional data were radially summed to produce a conventional one-dimensional diffraction pattern. The resulting pattern was subjected to profile fitting using the program ORIGIN (Origin Lab Co., Northhampton, Mass.) to separate amorphous and crystalline polymer scattering components. For profile fitting, a parabolic background model and a Gaussian peak shape model were employed Crystallinity index was evaluated as the ratio of crystalline scattering above background to total amorphous and crystalline scattering above background within the 10 to 35 degrees (2θ) scattering angle range.

Integrated Diffraction Intensity Ratio

The integrated diffraction intensity ratio (IDIR) is defined as the dimensionless ratio of the integrated intensity of a sample taken in the lengthwise-dimension (LD) to that of the transverse-dimension (TD), given as:

$$IDIR = \frac{integrated intensity of LD}{integrated intensity of TD}$$

Dynamic Mechanical Analysis (DMA)

Intrinsic modulus and stress strain analysis were conducted using a Dynamic Mechanical Analyzer (DMA). A DMA machine provides quantitative information on viscoelastic, Theological, and mechanical properties of a material by measuring the mechanical response of a sample as it is deformed under periodic stress or steady stress. The viscoelastic response of a sample is determined by precise measurement and control of temperature, time, frequency, amplitude, stress, and phase angle.

Forced frequency DMAs and Rheometers control oscillation frequency, strain amplitude, and test temperature or time in a continuous dynamic test. A typical test holds at least one of these variables constant while systematically varying the second and third. For example, a temperature sweep characterizes the temperature dependence of the rheological and mechanical properties of a material. This test mode also provides a sensitive means for measuring glass transition and other secondary transitions, knowledge of which can identify sample morphology, softening points, and useful temperature ranges.

Samples were measured using TAI Q800 and 2980 series DMAs (available from TA Instruments, New Castle, Del.) in single cantilever bending geometry. Room temperature (23-24° C.) experiments were performed on samples in dynamic mode for elastic modulus (intrinsic stiffness), and then under cyclic strain ramp to from 0-5% total strain over a total of 5 cycles. Values of modulus, peak stress, and return stress were reported in units of Mega Pascals (MPa). A “recovery efficiency” is also calculated as the percent of return stress to peak stress.

Effective Hydraulic Diameter

The effective hydraulic diameter Dₕ is used in the determination of the aspect ratio of noseclip elements, including individual strands or rectangular forms. The effective hydraulic diameter is the given as four times the cross-sectional area of noseclip element divided by the cross-sectional perimeter of the element. Hydraulic diameter Dₕ is given as:
Dₕ=4A/U
A=Crosss-sectional Area
U=Cross-sectional Perimeter
   For a cylindrical object with a diameter of dimension (D) the effective hydraulic diameter is D. For a square object with sides of length (L) the effective hydraulic diameter is L.

The following Examples have been selected merely to further illustrate features, advantages, and other details of the invention. Although the Examples serve this purpose, the particular ingredients and amounts used as well as other conditions and details are not to be construed in a manner that would unduly limit the scope of this invention.

### EXAMPLES

### Example 1

A nose clip of the invention was constructed and attached to a mask body. The nose clip included polyethylene (PE) strands manufactured by Mitsui Chemicals, Inc., Tokyo, Japan under the brand name of ‘TeknoRote’. The construction of the nose clip generally resembled the nose clip shown in FIGS. 1 and 3. Five 1.1 millimeter (mm) diameter PE strands were linked together in a flat side-by-side arrangement using a braided scaffold of nylon thread to hold them in parallel alignment. Spacing between the moldable strands was about 0.2 mm. The strands were about 114 mm long and had aspect ratios of about 145. Individual strands were tested for their degree of crystallinity using the Crystallinity Index Method and crystalline orientation using the Pole Figure Analysis. Pole figure images are shown in FIGS. 6 and 7 with accompanying plots of normalized intensity. FIG. 6 represents the lengthwise-dimension crystalline orientation of the sample with FIG. 7 representing the transverse-dimension crystalline orientation. Mechanical analyses were also conducted on the strands to determine modulus, peak stress, and return stress. The results for both the mechanical and morphologic analysis, including calculated values for Recovery Efficiency and Integrated Diffraction Intensity Ratio, are set forth in Table 1.

The above described strands moldable strands were affixed to a respirator for fit evaluation. The respirator used was a commercially available 8511™ particulate respirator manufactured by the 3M Company, St. Paul, Minn. The sole modification to the respirator was that the original nose clip was removed and was replaced with the inventive nose clip. The inventive nose clip was attached to the respirator using an ultrasonic welder. The welder was fitted with a horn that directed energy to an anvil that was placed inside the mask, at the end of each wing section 13 and 15 (FIG. 2). A Branson 2000 model ultrasonic welder was operated at a power setting of 12%, approximate chuck pressure of 130 KiloPascals (KPa) and weld time of 0.5 seconds. The resulting weld area was approximately 8 mm×8 mm on the centerline and at the ends of the fit component. The finished mask was fitted to a user and tested according to the Total Inward Leakage test.

### Example 2

A respirator was constructed as described in Example 1 except that the noseclip was affixed to the respirator using an adhesive. The adhesive was 3M Super 77 type spray adhesive, manufactured by 3M Company, St. Paul, Minn. Before applying the adhesive, the nose clip was contoured to the shape of the nose area of the respirator. Adhesive was applied uniformly to the entire underside of the contoured nose clip. After applying the adhesive, the nose clip was carefully pressed onto the respirator. Care was taken to not deform the shape of the mask body, while providing sufficient pressure to make a good bond between the mask body and the nose clip.

### Comparative Example 1

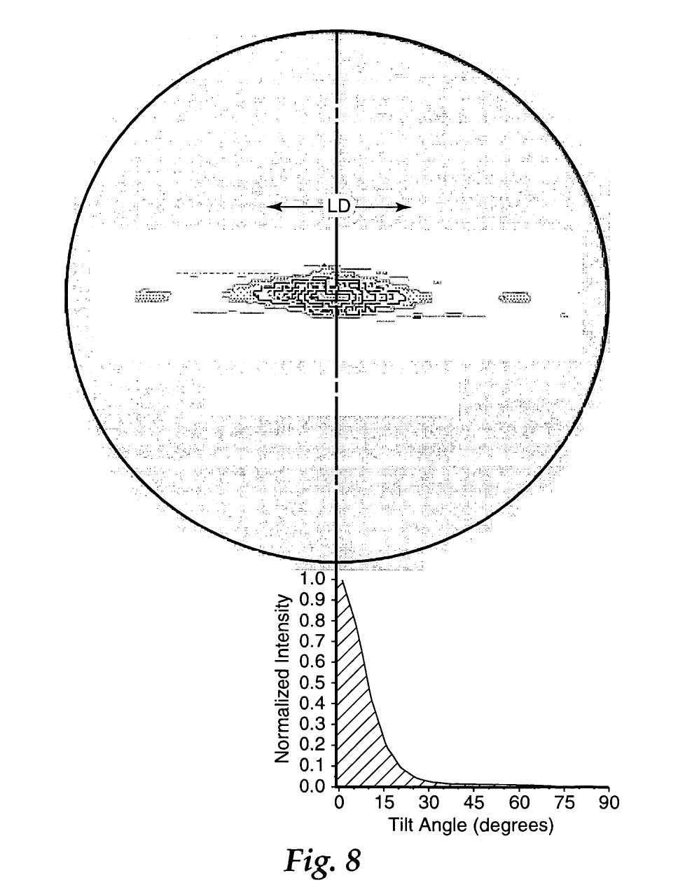

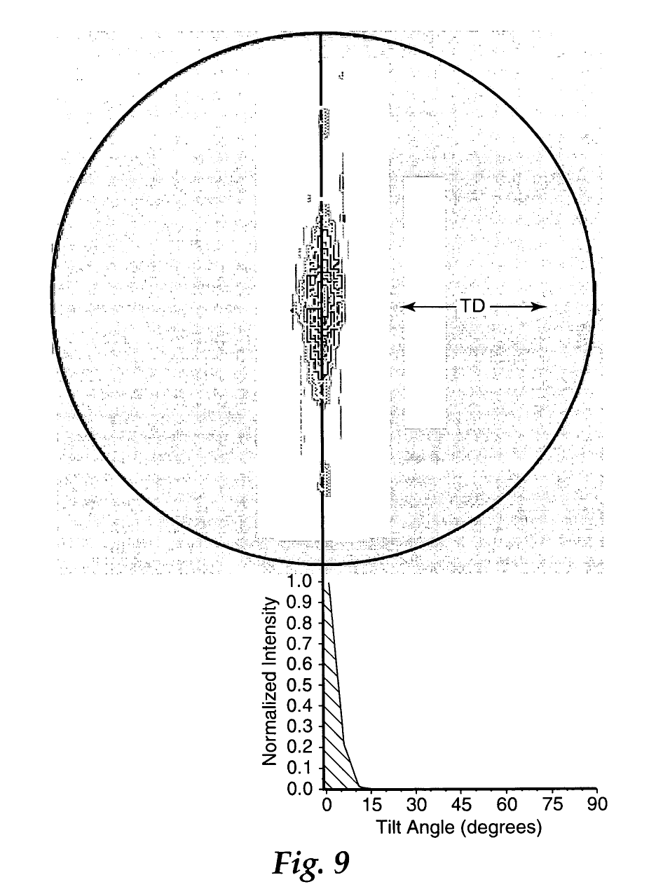

A polyethylene nose clip from a commercially available facemask (Toyo Safety, Miki City, Japan) was evaluated was evaluated for mechanical and morphologic properties. The nose clip was generally about 90 mm long and had a 3.65 mm×0.672 rectangular cross-section. The aspect ratio of the material was 79:1. The nose clip material was tested for degree of crystallinity using the Crystallinity Index Method. Crystalline orientation was determined in accordance with the X-Ray Diffraction Pole Figure Analysis. Pole figure images are shown in FIGS. 8 and 9 with accompanying plots of normalized intensity. FIG. 8 represents the lengthwise-dimension crystalline orientation of the sample with FIG. 9 representing the transverse-dimension crystalline orientation. Mechanical analyses were also conducted on the noseclip to determine modulus, peak stress, and return stress. The results for both the mechanical and morphologic analysis, including calculated values for Recovery Efficiency and Integrated Diffraction Intensity Ratio, are set forth in Table 1.

### Comparative Example 2

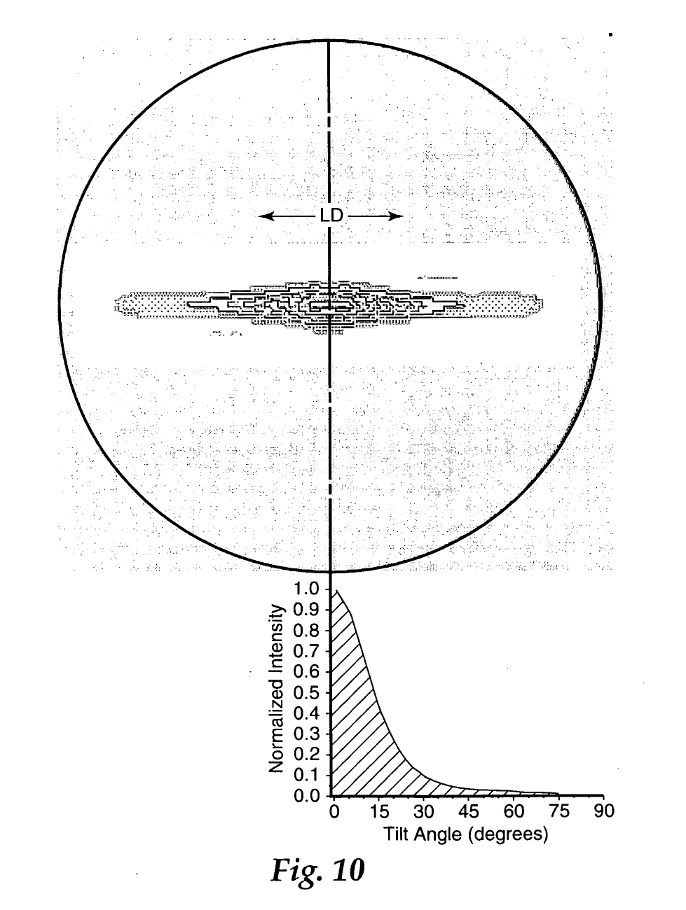

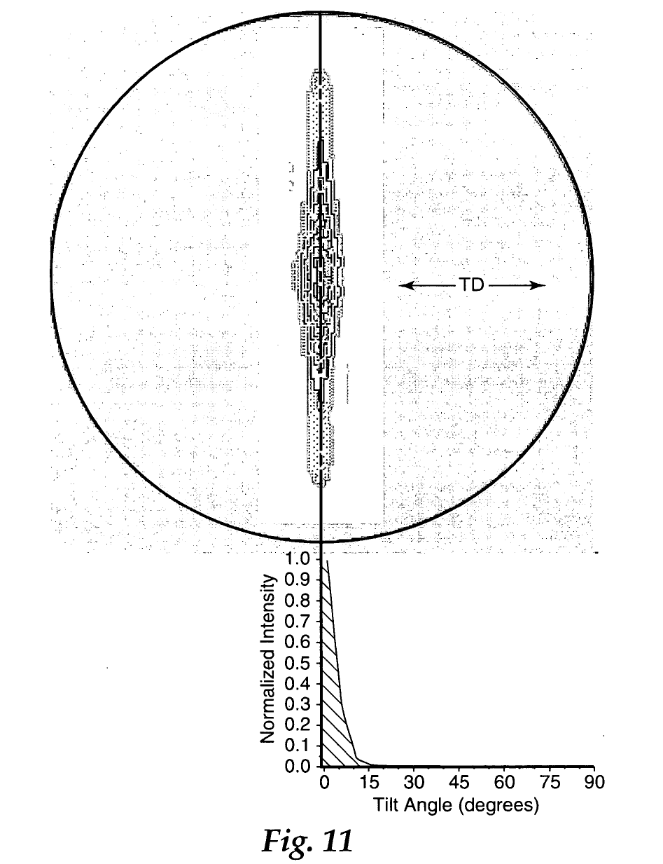

A polyethylene nose clip furnished to the 3M Company by Sekisui Chemical Co. Ltd. of Osaloa, Japan was evaluated. The nose clip material was generally about 90 mm long and had a 5.35 mm×0.95 mm rectangular cross-section. The aspect ratio of the material was about 56:1. The nose clip material was tested for degree of crystallinity using the Crystallinity Index Method. Crystalline orientation was determined in accordance with the X-Ray Diffraction Pole Figure Analysis. Pole figure images are shown in FIGS. 10 and 11 with accompanying plots of normalized intensity. FIG. 10 represents the lengthwise-dimension crystalline orientation of the sample with FIG. 11 representing the transverse-dimension crystalline orientation. Mechanical analyses were also conducted on the noseclip to determine modulus, peak stress, and return stress. The results for both the mechanical and morphologic analysis, including calculated values for Recovery Efficiency and Integrated Diffraction Intensity Ratio, are set forth in Table 1.

TABLE 1

| | Example | | |
|---|---|---|---|
| | 1 | C1 | C2 |
| Crystallinity Index | 0.75 | 0.76 | 0.46 |
| Integrated Diffraction Intensity, | 63 | 25 | 36 |
| Lengthwise-dimension (intensity- | | | |
| degrees) | | | |
| Integrated Diffraction Intensity, | 17 | 16 | 21 |
| Transverse-dimension intensity | | | |
| (-degrees) | | | |
| Integrated Diffraction Intensity Ratio | 3.7 | 1.6 | 1.7 |
| Elastic Modulus (MPa) | 14,567 | 15,642 | 10,280 |
| Peak Stress (MPa) | 223 | 648 | 118 |
| Return (recovery) Stress (MPa) | 115 | 274 | 44 |
| Recovery Efficiency (%) | 52 | 42 | 37 |

As is evident by the crystallography and intrinsic mechanical properties of the materials employed, the thermoplastic polymeric materials used in the inventive nose clips have a significantly higher recovery efficiency over a known thermoplastic nose clips. This can be attributed to the greater presence of uniaxial texture in the inventive nose clip as is observed by a greater integrated diffraction intensity in the lengthwise-dimension and integrated diffraction intensity ratio as compared that for the Comparative Examples. Greater recovery efficiency implies a better holding fit relative to the force required to achieve fit. Improvements in recovery efficiency translate into more comfortable fit without compromising the retained level of fit. An improvement in this parameter may also contribute to the distributive capacity of the inventive nose clip. Use of multiple strands in a nose clip may also provide a more uniform distribution of shape-retaining forces.

This invention may take on various modifications and alterations without departing from its spirit and scope thereof. Accordingly, this invention is not to be limited to the above described but is to be controlled by the limitations set forth in the following claims and any equivalents thereof

This invention may be suitably practiced in the absence of any element not specifically disclosed herein.

All patents and patent applications cited above, including those in the Background section, are incorporated by reference into this document in total.

What is claimed is:

1. A respirator that comprises:
(a) a mask body; and
(b) a nose clip that is secured to the mask body and that comprises a malleable semi-crystalline thermoplastic polymeric material that has an integrated diffraction intensity ratio of at least about 2.0.

2. The respirator of claim 1, wherein the nose clip has a lengthwise dimension and has an integrated diffraction intensity of at least about 40 in the lengthwise dimension.

3. The respirator of claim 1, wherein the polymeric material has a crystallinity index of at least about 0.5.

4. The respirator of claim 1, wherein the mask body comprises at least one layer of filter media that is supported by a molded shaping layer, and wherein the mask body has a harness attached thereto.

5. The respirator of claim 4, wherein the nose clip does not contain metal.

6. The respirator of claim 1, wherein the semi-crystalline thermoplastic polymeric material has controlled orientation within crystalline domains such that there is molecular alignment in a lengthwise-dimension of the molecular nose clip.

7. The respirator of claim 4, wherein the semi-crystalline thermoplastic polymeric material has orientation within crystalline domains such that there is molecular alignment in the lengthwise dimension of the nose clip.

8. The respirator of claim 7, wherein the polymeric material has a crystallinity index of at least about 0.6.

9. The respirator of claim 4, wherein the polymeric material has a crystallinity index of at least about 0.7.

10. The respirator of claim 4, wherein the polymeric material has an integrated diffraction intensity ratio of about least about 2.5.

11. The respirator of claim 1, wherein the polymeric material has an integrated diffraction intensity ratio of at least about 3.0.

12. The respirator of claim 1, wherein the polymeric material has an integrated diffraction intensity for the lengthwise dimension that is at least about 40 intensity-degree.

13. The respirator of claim 1, wherein the polymeric material has an integrated diffraction intensity for the lengthwise dimension that is at least about 50 intensity-degree.

14. The respirator of claim 1, wherein the polymeric material has an integrated diffraction intensity for the lengthwise dimension that is at least about 60 intensity-degree.

15. The respirator of claim 1, wherein the nose clips comprises a plurality of strands that have aspect ratios of at least 50.

16. The respirator of claim 15, wherein the nose clips comprises a plurality of strands that have aspect ratios of at least 100.

17. The respirator of claim 15, wherein the nose clips comprises a plurality of strands that have aspect ratios of at least 300.

18. The respirator of claim 15, wherein the strands are joined together by encasing them in a polymeric material.

19. The respirator of claim 15, wherein the plurality of strands are individually secured to the mask body.

20. The respirator of claim 15, wherein there are multiple layers of strands.

21. The respirator of claim 15, wherein the plurality of strands have a generally circular cross-section that has a diameter of about 0.3 to 1.5 millimeters.

22. The respirator of claim 15, wherein the plurality of strands are attached to a substrate material.

23. The respirator of claim 4, wherein the nose clip has a length of about 5 to 13 centimeters.

24. The respirator of claim 1, wherein the nose clip has a length of about 7 to 10 centimeters.

25. The respirator of claim 1, wherein the length of the semi-crystalline thermoplastic polymeric material is not less than 75% of the total nose clip length.

26. The respirator of claim 25, wherein the nose clip width is about 0.7 to 1.2 centimeters wide.

27. The respirator of claim 15, wherein the nose clip has 2 to 10 strands.

28. The respirator of claim 1, wherein the nose clip has a length of about 3 to 7 centimeters.

29. The respirator of claim 1, wherein the malleable nose clip is secured to the mask body through use of ultrasonic welding.

30. The respirator of claim 15, wherein the semi-crystalline thermoplastic polymeric material comprises a polymer that is selected from the group consisting of polyethylene, polypropylene, polyolefins, and combinations thereof.

31. The respirator of claim 1, wherein the semi-crystalline thermoplastic polymeric material has a recovery efficiency of at least 40%.

32. The respirator of claim 1, wherein the semi-crystalline thermoplastic polymeric material has a recovery efficiency of at least 50%.

33. The respirator of claim 1, wherein the semi-crystalline thermoplastic polymeric material has a recovery efficiency of at least 60%.

34. The respirator of claim 1, wherein the semi-crystalline thermoplastic polymeric material has an elastic modulus of 10,000 to 20,000 MPa.

35. The respirator of claim 1, wherein the semi-crystalline thermoplastic polymeric material has an elastic modulus of 14,000 to 16,000 MPa.

36. The respirator of claim 1, wherein the nose clip has a peak stress of not greater than 600 MPa.

37. The respirator of claim 1, wherein the nose clip has a peak stress of not greater than 400 MPa.

38. The respirator of claim 1, wherein the malleable nose clip has a return stress of at least 50 MPa.

39. The respirator of claim 1, wherein the malleable nose clip has a return stress of at least 100 MPa.

40. The respirator of claim 1, wherein the semi-crystalline thermoplastic polymeric material includes ingredients selected from the group comprising dyes, fillers, pigments, stabilizers, anti-microbial agents, and combinations thereof.

41. The respirator of claim 1, wherein the semi-crystalline thermoplastic polymeric material has a glass transition temperature of at least 35° C.

42. The respirator of claim 1, wherein the semi-crystalline thermoplastic polymeric material has a glass transition temperature of at least 50° C.

43. The respirator of claim 5, wherein the whole respirator lacks metal.

44. A method of disposing of a respirator, which comprises incinerating the respirator of claim 43.
